(19) United States
(12) Patent Application Publication
(10) Pub. No.: US 2023/0362291 A1
(43) Pub. Date: Nov. 9, 2023

(54) USB-C INTERFACE FOR A SMART DEVICE

(71) Applicant: Richard Klein, San Marcos, CA (US)

(72) Inventor: Richard Klein, San Marcos, CA (US)

(73) Assignee: Klein Electronics, Inc., Escondido, CA (US)

(21) Appl. No.: 17/662,139

(22) Filed: May 5, 2022

(51) Int. Cl. H04M 1/72409; H04M 1/02; H04W 4/10

(52) U.S. Cl. CPC H04M 1/724094; H04M 1/0274; H04W 4/10

(57) ABSTRACT

The present invention is directed to a method and apparatus for connecting an external composite device to a smart device such as a smartphone using a USB connection. The apparatus allows for the creation of a communication interface between an external composite device such as a PTT device and a smart device with a single USB connector. The interface allows the external device to control transmission and reception of digital audio while simultaneously supporting serial data packets being transmitted to control PTT Press and Release (press and hold) from a USBC-Serial connection. The apparatus may be used with both Android and Iphone smart devices.

### BACKGROUND OF THE INVENTION

### 1. Field of the Invention

The present invention relates to methods and apparatuses for interconnecting digital devices. More specifically, the invention relates to an improved apparatus and method for creating a composite USB interface for connecting to a composite device such as a PTT headset.

### 2. Description of the Prior Art

Push to talk (PTT) over cellular (POC) has been developed and refined over the years to allow for, among other things, the function of a two way radio using a smart phone. PTT has its advantages over a traditional cell phone or landline because of the direct, instant communication using radio frequencies. There are however drawbacks of this old technology, including range, number of speakers, security of the network, and the burden of having to carry an additional device.

PTT may be implemented on a smartphone by downloading a software application, which application will generate an interface, which may have a virtual PTT button in the form of one of the volume buttons on the phone or a GUI displayed on the smartphone. These virtual PTT buttons are generally effective but suffer from drawbacks. The smartphone application has to be opened before the button is generated, and (if truly virtual) it cannot be “felt”, it has to be seen which can be problematic in some workplace scenarios. Accordingly, external PTT devices have been developed. These devices typically output analog audio directly to a microphone/headphone input on a smartphone, which has drawbacks with respect to audio quality.

A composite USB device is a USB device that incorporates a plurality of host-accessible functions, but does not include a hub and has only one USB-device address.

In accordance with the above, the present invention is directed to a method and apparatus for connecting an external composite device to a smart device such as a smartphone using a USB connection. The apparatus allows for the creation of a communication interface between an external composite device such as a PTT device and a smart device with a single USB connector. The interface allows the external device to control transmission and reception of digital audio while simultaneously supporting serial data packets being transmitted to control PTT Press and Release (press and hold) from a USBC-Serial connection. The apparatus may be used with both Android and Iphone smart devices.

### SUMMARY OF THE INVENTION

It is a major object of the invention to provide a method and apparatus for connecting a composite class peripheral to a smart device using a USB connection.

It is another object of the invention to provide a method and apparatus for connecting an external PTT device to a smart device via a USB connection.

### BRIEF DESCRIPTION OF THE DRAWINGS

Various other objects, features, and attendant advantages of the present invention will become more fully appreciated as the same becomes better understood when considered with the accompanying drawings, in which like reference characters designate the same or similar parts throughout the several views, and wherein:

FIG. 1 shows a diagram illustrating the connection of an external PTT device to a smart device.

FIG. 2 is a flow diagram illustrating the functions of the PTT device firmware.

FIG. 3 is a list of commands for the main.c file of the inventive firmware.

FIG. 4 is a list of commands for the first device driver file of the inventive firmware.

FIG. 5 is a list of commands for a second device driver file of the inventive firmware.

FIG. 6 is a list of commands for a third device driver file of the inventive firmware.

### DETAILED DESCRIPTION OF THE PREFERRED EMBODIMENTS

The present invention is directed to a method and apparatus for connecting an external device to a smart device using a USB-C serial connection. In particular, the invention allows for connecting an external push to talk (PTT) device to a smart device such as a smartphone. This is accomplished by providing the device with customized hardware and associated firmware.

A device that has multiple interfaces controlled independently of each other is referred to as a composite device. A single USB interface can support a single USB device class. The HID (Human Interface Device) device class is typically used to implement button control functionality for devices such as keyboards, mouse, joystick, etc. The CDC communication device class provides a virtual communication port functionality to the USB host. The ADC class (Audio Device Class) is used to exchange streaming audio data between the USB host and the USB device. An external PTT device is an example of a composite device as it includes USB audio, microphone, and HID/CDC on a single USB connection.

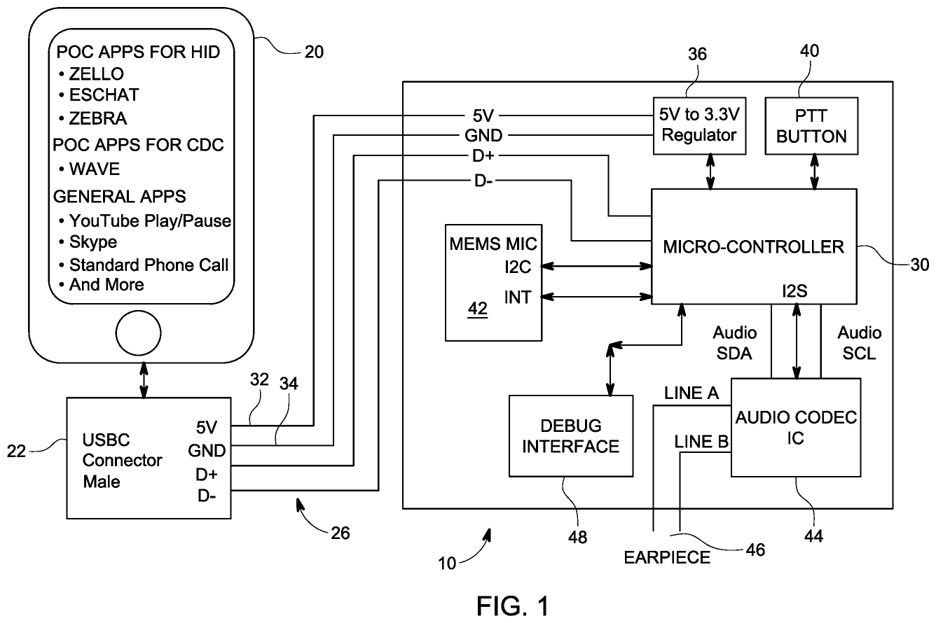

Referring now to FIG. 1, the inventive apparatus, generally designated by the numeral 10, is shown. The inventive apparatus 10 is an external push to talk PTT device having a pushbutton 40 for selectively allowing transmission and reception of audio via a smart device having a USB serial port. When connected to a smart device, the apparatus 10 allows the user to communicate to other users in the same manner as a two way talk radio.

It can be seen that the apparatus 10 is connected to a smart device, in the present case a smartphone 20. The smart device may be a tablet or other device as would be apparent to one of skill in the art. Prior to operation of the apparatus 10 in accordance with the inventive method, a suitable POC application is downloaded and installed on the smartphone 20, the details of which are not pertinent to the present invention disclosure, which is concerned with the configuration of the hardware and firmware required to interface an external PTT device to a smart device via a USB-C port. The smartphone 20, which is the host in the inventive configuration, may be an Android or Iphone with a USB-C serial port. A USB-C male connector 22 is connected to the smartphone 20, with the CC1 or CC2 pin connected to ground to produce a stable 5V operating voltage. The cabling arrangement 26 connected to the male connector 22 allows for connection to the various components of the apparatus 10 as will be discussed in more detail below. Power for the microprocessor 30 of the apparatus is supplied by cables 32, 34 connected to a voltage regulator 36 to provide the stable operating voltage for the microcontroller 30 in the well known manner. The actual push to talk button, diagrammatically represented as numeral 40, allows for the selective transmission of voice data via the USB-C port to the smartphone, pushing or releasing the button 40 initiates a series of actions as described below. Thus, the inventive interface allows the external device to control transmission and reception of digital audio while simultaneously supporting serial data packets being transmitted to control PTT Press and Release (press and hold) from a USBC-Serial connection. The microphone module 42 is a MEMS type chip and is connected to microcontroller 30 via an i2c interface. The i2s output of the microcontroller 30 is connected to an audio codec chip 44 which converts the audio to analog for output to an earpiece or other audio transducer. A debug interface 48 is also connected to microcontroller 30 and functions in the well known manner.

An endpoint is a buffer on a USB device. Endpoint is a term that relates to the hardware itself, independent of the host operating system. The host can send and receive data to or from that buffer. Endpoints can be categorized into control and data endpoints. A key aspect of the invention is that the microcontroller 30 has sufficient endpoints. To that end, the microcontroller 30 has a total of 4 bidirectional endpoints, one of which is a control endpoint and the other three are general endpoints. The first of the general endpoints are USB ADC (analog to digital converter) for speaker and microphone. USB ADC has 1 EP OUT and 1 EP IN. The second is USB HID which is needed for the PTT Button 40. When the user presses and release the button 40, the microcontroller 30 sends an HID command to the smartphone 20 via the USB. USB HID has 1 EP OUT and 1 EP IN. The third is USB CDC which is needed for VCOM Serial communication. When the user presses and releases the button 40, microcontroller 40 sends a special string via the USB COM Port. USB CDC has 1 EP IN for control, 1 EP IN and 1 EP OUT for data transfers.

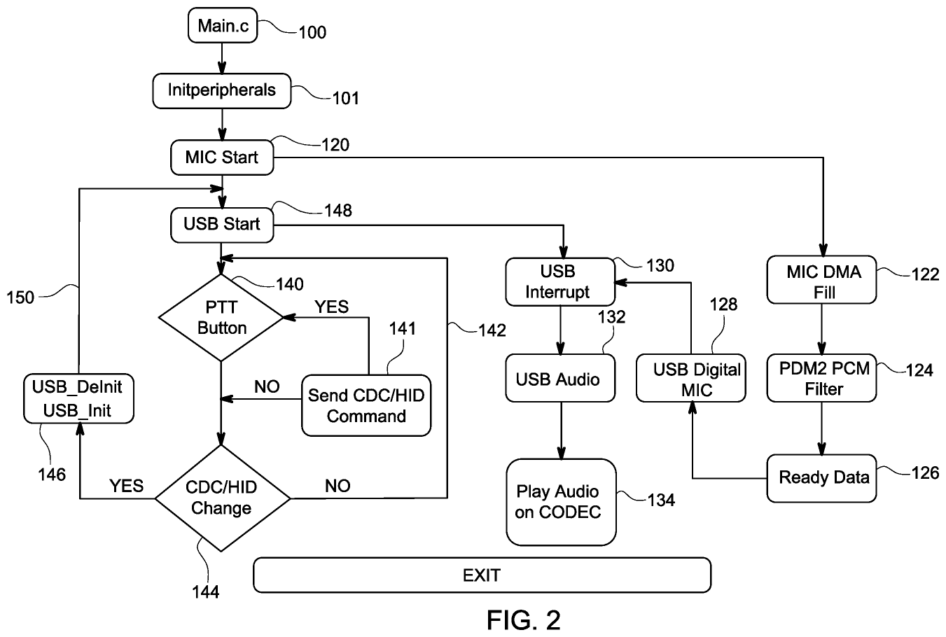

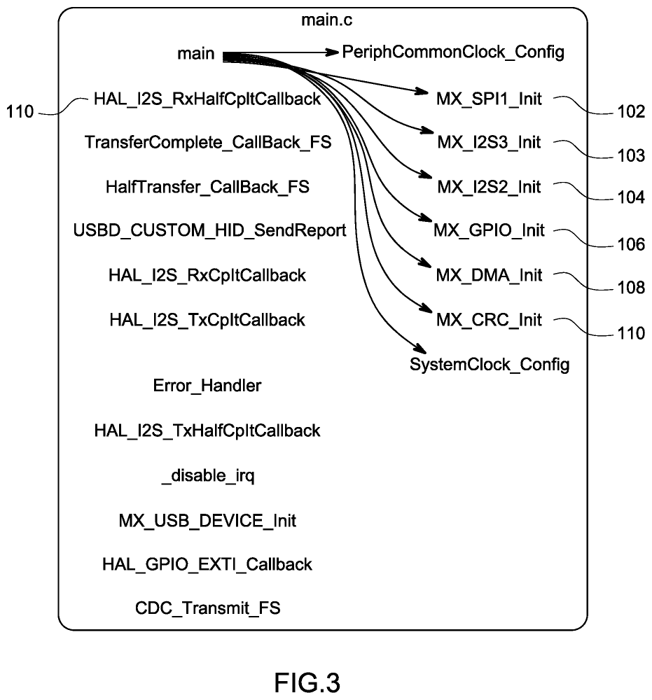

Referring now particularly to FIGS. 2 and 3 a flow diagram and sequential list of commands for the main.c file 100 of the inventive firmware are shown. In accordance with the inventive method, composite devices are supported by creating a virtual USB disk. The disk can store the 3 different device drivers so that those drivers can be accessed anytime and at the same time. The main.c file for the inventive firmware starts by initializing (101) all peripheral devices; SPI 102, I2S2, I2S3, 103, 104, GPIO 106, DMA 108, CRC 110, as well as the peripheral clock and system clock. SPI is used to control the CODEC chip 44. I2S2 103 is used for communication with the CODEC chip 44. It works as callback cycle 110 and data is stored in DMA buffer as seen in block 122. I2S3 104 is used for communication with the MEMS microphone. This works as callback cycle and data is received in the DMA buffer. The data in the DMA buffer is filtered by a PDM2PCM filter. This functionality is illustrated in blocks 120, 122, and 124. The microphone data is prepared and digitized in blocks 126 and 128. A USB interrupt is generated and the USB audio is sent to the CODEC chip for output to the earpiece as seen in blocks 130, 132, and 134. If the PTT button 40 is depressed 140, a CDC/HID command is generated 141, with the status of the PTT button 40 constantly polled as seen in loop 142. The CDC/HID status, i.e., whether the PTT 40 button is pressed or released, is monitored in blocks 144, 146, 148 which form another loop 150.

The device drivers are the usbd_audio_mic.c file; the usbd_cdc.c, usbd_cdc_if.c files; and the usbd_customhid.c, usbd_custom_hid_if.c files.

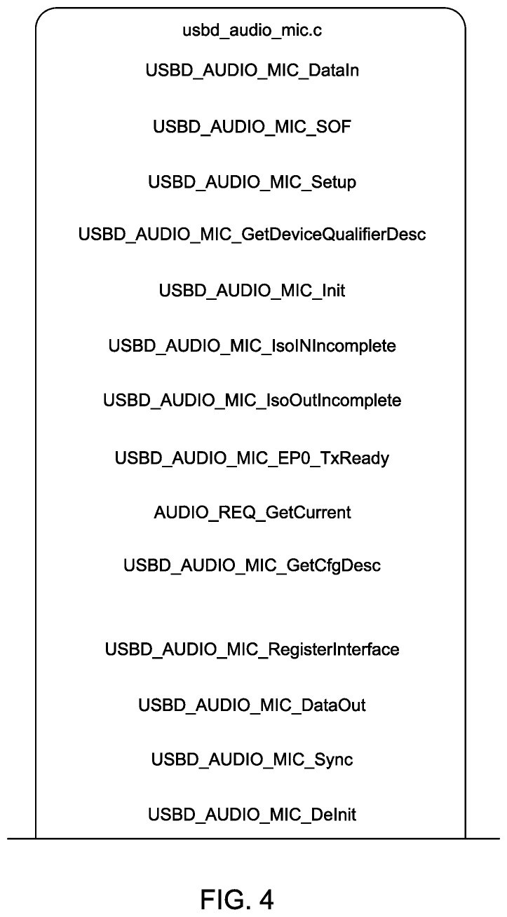

The usbd_audio_mic.c file is shown in FIG. 4. The USB_AUDIO_MIC_DataIn function 160 is for transferring MID data. The USB_AUDIO_MIC_DataOut function is for transfer of CODEC data via the codec chip 44.

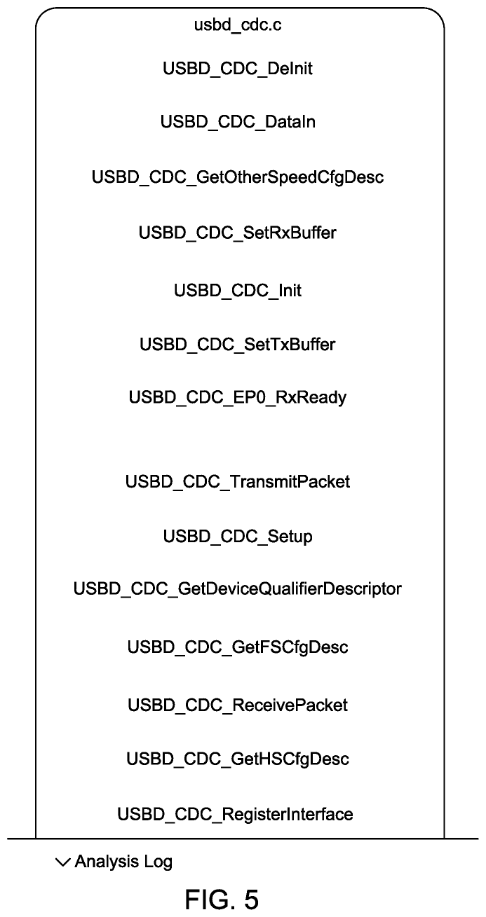

The usbd_cdc.c and usbd_cdc_ific files are shown in FIG. 5. The USBD_CDC_SetTxBuffer( ) function sends a special string by using the endpoints in this function:

| | |
|---|---|
| int rain(void) | |
| { | |
| /* USER CODE BEGIN 1 */ | |
| uintB_t USB/TXbuffer[20]; | |
| ///////////////////////////////////////////////////////////////////////////////////////// | // |
| // /* Button */ | // |
| | // |
| Cnt.Pcnt=HAL_GPID_ReadPin(PTT_BIN_GPID_Port, | |
| PTT_BIN_Pin); | |
| if(Cnt.Pcnt!=Cnt.Acnt){ | // |
| [symbol] | // |
| // check press state | // |
| if(Cnt.Pcnt==1){ | // |
| if (mode [symbol] ) | // |
| { | |
| CDC_Transmit_F5(IN_TXdata, strlen(IN_TXdata)); | |
| HAL_Delay(250); | |
| CDC_Transmit_F5(PP_TXdata, strlen(PP_TXdata)); | |
| HAL_Delay(250); | |
| } | |
| else | // |
| { | |
| USB_TXbuffer[1]= [symbol] ; | // |
| USBD_CUSTOM_HID_SendReport( [symbol] ; | // |
| USB_TXbuffer, 2); | |
| HAL_Delay(100), | // |
| } | |
| } | // |
| // check release state | // |
| if(Cnt.Pcnt==0){ | // |
| if (mode [symbol] ) | // |
| { | |
| CDC_Transmit_F5(PR_TXdata, strlen(PR_TXdata)); | |
| HAL_Delay(250); | |
| } | |
| else | // |
| { | |
| USB_TXbuffer[1]=0; | // |
| USBD_CUSTOM_HID_SendReport( [symbol] ; | // |
| USB_TXbuffer, 2); | |
| HAL_Delay(100); | |
| } | |
| } | // |
| } | // |
| ///////////////////////////////////////////////////////////////////////////////////////// | // |

[symbol]

indicates data missing or illegible when filed

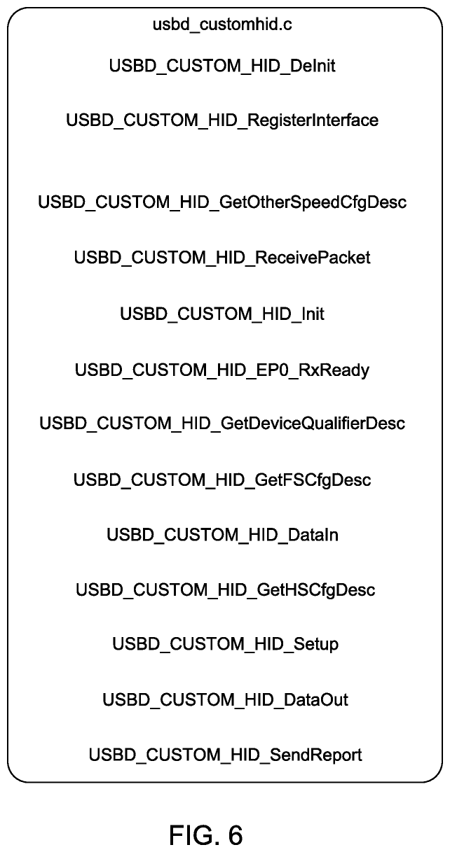

The usbd_customhid.c and usbd_custom_hid_if.c file are shown in FIG. 6. The USBD_CUSTOM_HID_SendReport( ) function operates as follows; when the user presses button 40, the microcontroller sends a special string by using the endpoints in this function:

| | |
|---|---|
| ///////////////////////////////////////////////////////////////////////////////////////// | // |
| // /*HID Button * | // |
| | // |
| Cnt.Pcnt-HAL_GPIO_ReadPin(PTT_BIN_GPIO_Port, | |
| PTT_BIN_Pin); | |
| if(Cnt.Pcnt!=Cnt.Acnt){ | // |
| Cnt.Rcnt-Cnt.Pcnt; | // |
| // check press state | // |
| if(Cnt.Pcnt==1){ | // |
| if (modeCDC) | // |
| { | |
| CDC_Transmit_F5(IN_TXdata, strlen(IN_TXdata)); | |
| HAL_Delay(250); | |
| CDC_Transmit_F5(PP_TXdata, strlen(PP_TXdata)); | |
| HAL_Delay(250); | |
| } | |
| else | // |
| { | |
| USB_TXbuffer[1]= [symbol] ; | // |
| USBD_CUSTOM_HID_SendReport( [symbol] UsbDeviceF5, | // |
| USB_TXbuffer, 2){ | |
| HAL_Delay(100); | // |
| } | |
| } | // |
| // check release state | // |
| If(Cnt.Pcn ==0){ | // |
| if (modeCDC) | // |
| { | |
| CDC_Transmit_F5(PR_TXdata, strlen(PR_TXdata)); | |
| HAL_Delay(250); | |
| } | |
| else | // |
| { | |
| USB_TXbuffer[1]=0, | // |
| USBD_CUSTOM_H\|ID_SendReport( [symbol] UsbDeviceF5, | // |
| USB_TXbuffer, 2); | |
| HAL_Delay(300); | // |
| } | |
| } | // |
| } | // |
| ///////////////////////////////////////////////////////////////////////////////////////// | // |

[symbol]

indicates data missing or illegible when filed

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the sole embodiment described above, but encompasses any and all embodiments within the scope of the following claims:

I claim:

1. A communication system, comprising: a portable communication device having an external headset with a push to talk button and a microcontroller; an interface for coupling the portable communication device to a host device, the interface comprising a USB-C interface, the USB-C interface being configured by the microcontroller to control transmission and reception of digital audio from and to said external headset while simultaneously supporting control signals generated by operation of said push to talk button.

2. The system of claim 1 wherein said portable communication device includes an audio codec chip for outputting audio to an audio transducer.

3. The system of claim 1 wherein said host device is a smart device.

4. The system of claim 3 wherein said smart device is a smart phone.

5. The system of claim 1 wherein said microcontroller is programmed to establish 4 bi-directional endpoints.

6. The system of claim 5 wherein one of said endpoints is a control endpoint.

7. The system of claim 5 where one of said endpoints is a USB ADC endpoint for speaker and microphone.

8. The system of claim 5 where one of said endpoints is a USB HID endpoint for responding to pressing and releasing of said push to talk button.

9. The system of claim 5 where one of said endpoints is a USB CDC endpoint for establishing VCOM serial communication.
